(19) United States
(12) Patent Application Publication
(10) Pub. No.: US 2008/0182923 A1
(43) Pub. Date: Jul. 31, 2008

(54) COMPOSITION FOR MANUFACTURING INSULATION MATERIALS OF ELECTRICAL WIRE AND ELECTRICAL WIRE MANUFACTURED USING THE SAME

(76) Inventors: Do-Hyun Park, Gyeonggi-do (KR); Jin-Ho Nam, Seoul (KR); Ung Kim, Gyeonggi-do (KR); Yong-Sun Lee, Gyeongbuk (KR)

Correspondence Address: JONES DAY, 222 EAST 41ST ST, NEW YORK, NY, 10017, US

(21) Appl. No.: 11/937,191

(22) Filed: Nov. 8, 2007

(30) Foreign Application Priority Data
Jan. 25, 2007 (KR) 10-2007-8088

(51) Int. Cl. C08K 3/00

(52) U.S. Cl. 523/173

(57) ABSTRACT

The present invention relates to a composition for manufacturing insulation materials of an electrical wire and an electrical wire manufactured using the same. The composition for manufacturing insulation materials of an electrical wire according to the present invention includes 100 parts by weight of a base resin, made by blending 20 to 70 weight % of any one resin of an unsaturated organosilane grafted polyethylene and an unsaturated organosilane grafted ethylene alpha olefine copolymer, and 30 to 80 weight % of an unsaturated organosilane grafted ethylene copolymer; 10 to 25 parts by weight of a brominated flame retardant; 10 to 50 parts by weight of an inorganic flame retardant; and 0.2 to 5 parts by weight of compound, as a crosslink retardant, represented as a general formula of XₙSi(OR)₄₋ₙ (X is a phenyl group, R is a methyl group and n is an integer of 1 to 3).

### BACKGROUND OF THE INVENTION

1. Field of the Invention

The present invention relates to a composition for manufacturing insulation materials of an electrical wire and an electrical wire manufactured using the same, and in particular, to a composition for manufacturing insulation materials of an electrical wire, which has excellent flame retardancy and flame resistance as well as heat resistance and oil resistance to minimize damage of lives and equipment that may occur in case of fire, and to an electrical wire manufactured using the same.

2. Description of the Related Art

Conventionally, to manufacture an insulator and a sheath of an electrical wire, an unsaturated organosilane is grafted to polyethylene or an ethylene copolymer. However, grafting of the unsaturated organosilane to polyethylene and otherwise may increase a melting viscosity of a resin to cause a high load when extruding the insulator and the sheath of the electrical wire, thereby resulting in unpreferable influence such as scotch generation.

To solve the problem, U.S. Pat. No. 5,430,091 suggested to blend polyethylene not containing an unsaturated organosilane, and settled the melting viscosity rise problem. However, the blending of polyethylene not containing an unsaturated organosilane disadvantageously results in unsatisfied crosslinking density when crosslinking by water. Low crosslinking density does not meet oil resistance, thermal distortion or requirements in a hot set test, and thus it is not proper for use as an electrical wire material having a use environment of high temperature condition.

Therefore, the related industry has attempted to develop a composition for manufacturing insulation materials of an electrical wire, which is free of scotches caused by high melting viscosity and has excellent oil resistance, heat resistance, flame resistance and flame retardancy, while maintaining characteristics such as tensile strength and elongation when heating, and the present invention was devised under this technical background.

The present invention is designed to solve the above-mentioned problems of the prior art, and therefore it is an object of the present invention to provide a composition for manufacturing insulation materials of an electrical wire, which solves a scotch problem caused by high melting viscosity and at the same time, improves heat resistance, oil resistance and flame retardancy, and to provide an electrical wire manufactured using the same.

### SUMMARY OF THE INVENTION

In order to achieve the above-mentioned objects, the present invention provides a composition for manufacturing insulation materials of an electrical wire including 100 parts by weight of a base resin, made by blending 20 to 70 weight % of any one resin of an unsaturated organosilane grafted polyethylene and an unsaturated organosilane grafted ethylene alpha olefine copolymer, and 30 to 80 weight % of an unsaturated organosilane grafted ethylene copolymer; 10 to 25 parts by weight of a brominated flame retardant; 10 to 50 parts by weight of an inorganic flame retardant; and 0.2 to 5 parts by weight of a compound, as a crosslink retardant, represented as a general formula of XₙSi(OR)₄₋ₙ (X is a phenyl group, R is a methyl group and n is an integer of 1 to 3).

The polyethylene may include a low density polyethylene, a linear low density polyethylene or a high density polyethylene, and typically the ethylene alpha olefine copolymer may include butene-1, pentene-1, hexene-1, heptene-1, octene-1, 4-methylpentene-1, 4-methylhexene-1, 4,4-dimethylpentene-1, nonene-1, decene-1, undecene-1 or dodecene-1. Preferably, the ethylene copolymer may include ethylene acetate vinyl copolymer, ethylene ethyl acrylate copolymer, ethylene methyl methacrylate copolymer or ethylene butyl acrylate copolymer, and acetate vinyl, ethyl acrylate, methyl methacrylate and butyl acrylate each has the content of 9 to 33 weight % in the unsaturated organosilane grafted ethylene acetate vinyl copolymer, the unsaturated organosilane grafted ethylene ethyl acrylate copolymer, the unsaturated organosilane grafted ethylene methyl methacrylate copolymer and the unsaturated organosilane grafted ethylene butyl acrylate copolymer, respectively. The composition for manufacturing insulation materials of an electrical wire may further include antimony trioxide, a lubricant or an antioxidant.

The present invention provides an electrical wire manufactured using the above-mentioned composition for manufacturing insulating materials of an electrical wire.

### BRIEF DESCRIPTION OF THE DRAWINGS

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

FIG. 1 is a cross-sectional view illustrating a structure of an electrical wire manufactured using a composition according to examples 1 to 6 and comparative examples 1 to 4.

### DESCRIPTION OF THE PREFERRED EMBODIMENT

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

A composition for manufacturing insulation materials of an electrical wire according to the present invention includes a base resin, a brominated flame retardant, an inorganic flame retardant and a crosslink retardant.

The base resin is made by blending 20 weight % to 70 weight % of any one resin of an unsaturated organosilane grafted polyethylene and an unsaturated organosilane grafted ethylene alpha olefine copolymer, and 30 weight % to 80 weight % of an unsaturated organosilane grafted ethylene copolymer. In the case that the content of the unsaturated organosilane grafted ethylene copolymer is less than the minimum, the content of polyethylene reduces due to use of an excessive amount of organic and inorganic additives, thereby rapidly reducing elongation and flame retardancy. And, in the case that the content of the unsaturated organosilane grafted ethylene copolymer is more than the maximum, it could not expect a mechanical property improving effect due to application of a crystalline resin.

Preferably, the ethylene copolymer may include ethylene acetate vinyl copolymer, ethylene ethyl acrylate copolymer, ethylene methyl methacrylate copolymer or ethylene butyl acrylate copolymer, preferably acetate vinyl, ethyl acrylate, methyl methacrylate and butyl acrylate each has the content of 9 to 33 weight % in the unsaturated organosilane ethylene acetate vinyl copolymer, the unsaturated organosilane ethylene ethyl acrylate copolymer, the unsaturated organosilane ethylene methyl methacrylate copolymer and the unsaturated organosilane ethylene butyl acrylate copolymer, respectively, and in the case that the content is less than the minimum, elongation reduces due to reduction of compatibility with the inorganic flame retardant, and in the case that the content is more than the maximum, it is difficult to obtain a desired value of mechanical property.

To get UL4 VW-1 flame retardancy grade, preferably the brominated flame retardant may include decabromodiphenylethylene, decabromodiphenyloxide and ethylene bis tetra bromophthalimide. Preferably, the brominated flame retardant has the content of 10 to 25 parts by weight based on 100 parts by weight of the base resin. In the case that the content of the brominated flame retardant is less than the minimum, it is difficult to obtain a desired flame retardancy, and in the case that the content of the brominated flame retardant is more than the maximum, it results in much flame retardancy and reduction of elongation due to use of an excessive content of flame retardant.

Preferably, the inorganic flame retardant may include calcium carbonate, magnesium hydroxide or aluminum hydroxide that is surface treated with vinyl silane, stearic acid, oleic acid, amino polysiloxane or a high molecular weight resin. The surface treatment of the inorganic flame retardant allows to suppress a crosslink reaction of a hydroxyl group (—OH) of the inorganic flame retardant and an alkoxy group of the unsaturated organosilane during compounding, storing, or extruding process. As a result, the crosslink reaction is suppressed during compounding and storing processes to facilitate the extruding process and consequently form an excellent extruded appearance, thereby obtaining excellent quality of an electrical wire and good mechanical property of insulation materials. Preferably, the inorganic flame retardant has the content of 10 to 50 parts by weight based on 100 parts by weight of the base resin. In the case that the content of the inorganic flame retardant is less than the minimum, it could not expect improved flame retardancy, and in the case that the content of the inorganic flame retardant is more than the maximum, tensile strength, elongation and heat resistance rapidly reduce due to an excessive amount of inorganic material and the viscosity of the composition increases, thereby resulting in uneasy extruding process.

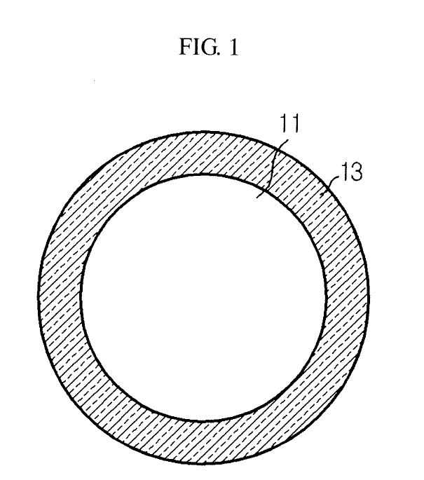

The crosslink retardant includes a compound represented as a general formula of XₙSi(OR)₄₋ₙ (X is a phenyl group, R is a methyl group and n is an integer of 1 to 3). A structural formula of the compound is shown in the following Chemistry FIG. 1. During processing, a silane grafted resin is hydrolyzed and crosslinked by moisture in the air or water contained in the inorganic flame retardant to generate a scotch, which is a fatal disadvantage in a crosslinkable composition, and the present invention uses the above-mentioned crosslink retardant to solve the problem. Preferably, the crosslink retardant has the content of 0.2 to 5 parts by weight based on 100 parts by weight of the base resin. In the case that the content of the crosslink retardant is less than the minimum, it could not expect a scotch suppressing effect, and in the case that the content of the crosslink retardant is more than the maximum, flame retardancy and tensile strength reduce due to use of an excessive amount of organic material.

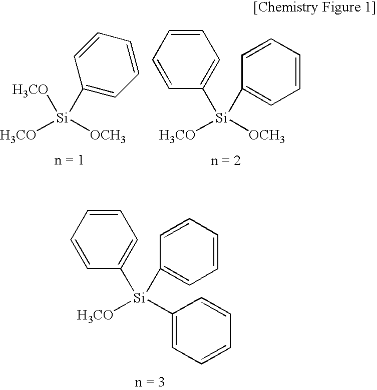

The composition for manufacturing insulation materials of an electrical wire according to the present invention may further include a flame retardant synergist, an antioxidant or a lubricant, as well as the base resin, the flame retardant and the crosslink retardant. The flame retardant synergist uses antimony trioxide to improve flame retardancy of the composition through synergism with the brominated flame retardant. Preferably, the flame retardant synergist has the content of 5 to 15 parts by weight based on 100 parts by weight of the base resin, and in the case that the content of the flame retardant synergist is less than the minimum, it could not expect a synergy effect for flame retardancy with the brominated flame retardant, and in the case that the content of the flame retardant synergist is more than the maximum, tensile strength and elongation reduce due to addition of an excessive amount of flame retardant synergist and it could not expect a flame retardancy improving effect. Preferably, the antioxidant includes amine-based, dialkylester-based, thioester-based or phenol-based antioxidant, and has the content of 0.5 to 5 parts by weight based on 100 parts by weight of the base resin. In the case that the content of the antioxidant is less than the minimum, a mechanical property reduces due to a thermal oxidation of the resin during processing, and in the case that the content of the antioxidant is more than the maximum, a whitening phenomenon occurs and a physical property reduces due to a problem in compatibility with the resin. The lubricant may include a high molecular weight wax, a low molecular weight wax, a polyolefine wax, a paraffin wax, paraffin oil, stearic acid, metal soap, organosilicone, fatty acid ester, fatty acid amide, fatty alcohol or fatty acid, preferably has the content of 0.5 to 5 parts by weight based on 100 parts by weight of the base resin, and in the case that the content of the lubricant is less than the minimum, elongation reduces remarkably and in the case that the content of the lubricant is more than the maximum, tensile strength does not meet a desired value.

Hereinafter, as shown in the following Table 1, compositions are classifiably set into examples (1 to 6) and comparative examples (1 to 4), and various evaluations are performed on material samples and electrical wires manufactured from the compositions so that technical effects of the present invention are described in detail.

### EXAMPLES (1 TO 6) AND COMPARATIVE EXAMPLES (1 TO 3)

A sample for measuring a physical property was manufactured such that a composition shown in the following Table 1 was mixed in an open roll of about 120° C., molded in a press of temperature of 170° C. for 20 minutes, and water crosslinked in a warm water of 100° C. or less for about 8 hours. And, as shown in FIG. 1, an electrical wire having a conductor 11 and an insulation material 13 was manufactured using the composition made according to the following Table 1. At this time, the insulation material 13 of the electrical wire had a thickness of 0.5 to 5 mm. The manufactured sample was tested for the following mechanical property, mechanical property after heating, smoke index, oil resistance and hot set, and VW-1 flame retardancy grade was evaluated using the electrical wire. Further, extrudability of each material was measured.

TABLE 1

| | Examples | | | | | | Comparative examples | | | |
|---|---|---|---|---|---|---|---|---|---|---|
| Ingredient | 1 | 2 | 3 | 4 | 5 | 6 | 1 | 2 | 3 | 4 |
| Resin a | 50 | 50 | 50 | 50 | 45 | — | 50 | 50 | 50 | — |
| Resin b | 50 | — | — | 50 | 45 | 70 | 50 | 50 | — | 50 |
| Resin c | — | 50 | — | — | — | — | — | — | — | 50 |
| Resin d | — | — | 50 | — | — | — | — | — | — | — |
| Resin e | — | — | — | — | 10 | — | — | — | — | — |
| Resin f | — | — | — | — | — | 30 | — | — | — | — |
| Resin g | — | — | — | — | — | — | — | — | 50 | — |
| Antioxidant | 3.5 | 3.5 | 3.5 | 3.5 | 3.5 | 3.5 | 3.5 | 3.5 | 3.5 | 3.5 |
| Brominated | 40 | 40 | 40 | 25 | 40 | 40 | 40 | 40 | 40 | 40 |
| flame | | | | | | | | | | |
| retardant | | | | | | | | | | |
| Antimony | 20 | 20 | 20 | 12 | 20 | 20 | 20 | 20 | 20 | 20 |
| trioxide | | | | | | | | | | |
| Magnesium | 40 | 40 | 40 | 30 | 40 | 40 | 40 | — | 40 | 40 |
| Hydroxide | | | | | | | | | | |
| Lubricant | 2 | 2 | 2 | 2 | 2 | 2 | 2 | 2 | 2 | 2 |
| Crosslink | 0.5 | 0.5 | 0.5 | 0.5 | 0.5 | 0.5 | — | 0.5 | 0.5 | 0.5 |
| retardant | | | | | | | | | | |

In the above Table 1, the resin a is an unsaturated organosilane grafted ethylene-vinyl acetate copolymer resin containing 19% of vinyl acetate, the resin b is an unsaturated organosilane grafted low density polyethylene, the resin c is an unsaturated organosilane grafted linear low density polyethylene, the resin d is an unsaturated organosilane grafted ethylene-butene copolymer resin, the resin e is a maleic anhydride grafted low density polyethylene, the resin f is an unsaturated organosilane grafted ethylene-methyl acrylate copolymer containing 29% of methylacrylate, and the resin g is a low density polyethylene. And, the brominated flame retardant is decabromodiphenylethylene, the crosslink retardant is X₁Si(OR)₃ and X₃Si(OR)₁, and the magnesium hydroxide was surface treated with vinyl silane.

Evaluation of Characteristics

Evaluation was made on characteristics of the samples and electrical wires according to the above examples and comparative examples, and evaluation results are shown in the following Table 2.

1) Characteristic at Room Temperature

Tensile strength and elongation were measured at tensile speed of 500 mm/min. according to UL44. The tensile strength should be 1.05 kgf/mm² or more and the elongation should be 150% or more.

2) Tensile Retention and Elongation Retention after Heating

The sample was kept in ULA4 at temperature of 121° C. for 168 hours, and then rates of change of tensile strength and elongation were measured. Each of tensile retention and elongation retention should be 70% or more.

3) Hot Set

The sample in the form of a dumb bell was applied by load of 20 N/cm², kept at temperature of 200° C. for 15 minutes, and then its length was measured, and after removal of the load, the sample was kept at 200° C. for 5 minutes, taken out, and slowly cooled, and its length was measured, and at this time, the length in the former measurement should not change 175% or more of an original length and the length in the latter measurement should not change 15% or more of an original length.

4) VW-1 Flame

Evaluation was made according to UL44 54.1

5) Horizontal Flame

Evaluation was made according to UL44 53.1

6) Oil Resistance

The sample was kept in IRM902 oil at temperature of 75° C. for 60 days, and when rates of change of tensile strength and elongation were measured, each of tensile retention and elongation retention should be 60% or more.

7) Extrudability

Extrudability was evaluate d according to appearance and load when extruding. In the case of excellent appearance and low load, it was evaluated as “excellent”, in the case of good appearance and a small rise in load, it was evaluated as “good”, and in the case of bad appearance and scotch generation, it was evaluated as “bad”.

8) VW-1 Flame

Evaluation was made according to ULA4 55.1-55.4.

9) Smoke Index

Smoke index was measured according to NES 711.

TABLE 2

| | | Examples | | | | | | Comparative Examples | | | |
|---|---|---|---|---|---|---|---|---|---|---|---|
| Classification | | 1 | 2 | 3 | 4 | 5 | 6 | 1 | 2 | 3 | 4 |
| At room | Tensile | 1.18 | 1.12 | 1.10 | 1.15 | 1.17 | 1.07 | 1.05 | 1.21 | 1.31 | 0.98 |
| temperature | strength | | | | | | | | | | |
| | (kgf/mm²) | | | | | | | | | | |
| | Elongation | 237 | 186 | 175 | 246 | 156 | 263 | 142 | 251 | 270 | 115 |
| | (%) | | | | | | | | | | |
| After | Tensile | 91 | 78 | 88 | 97 | 90 | 95 | 95 | 89 | 75 | 92 |
| heating | retention | | | | | | | | | | |
| | (%) | | | | | | | | | | |
| | Elongation | 95 | 101 | 84 | 91 | 89 | 95 | 93 | 88 | 91 | 97 |
| | retention | | | | | | | | | | |
| | (%) | | | | | | | | | | |
| Hot set | | Pass | pass | pass | pass | pass | pass | pass | pass | failure | pass |
| Smoke density | | 22 | 23 | 25 | 21 | 23 | 20 | 23 | 38 | 27 | 25 |
| VW-1 | | success | success | success | N/A | success | success | success | rejection | success | success |
| Horizontal flame | | N/A | N/A | N/A | success | N/A | N/A | N/A | N/A | N/A | N/A |
| Extrudability | | Good | good | good | good | good | good | bad | good | good | bad |
| Oil | Tensile | 81 | 89 | 65 | 75 | 89 | 80 | 80 | 70 | 49 | 83 |
| resistance | retention | | | | | | | | | | |
| | (%) | | | | | | | | | | |
| | Elongation | 86 | 67 | 63 | 79 | 91 | 79 | 75 | 65 | 55 | 85 |
| | retention | | | | | | | | | | |
| | (%) | | | | | | | | | | |

(A horizontal flame test was performed on only the example 4, and VW-1 test was performed on the other examples and comparative examples)

The examples 1 to 6 met UL44 VW-1 flame retardancy standard, and used only the unsaturated organosilane grafted polyethylene based resin to obtain high crosslinking density, thereby exhibiting a satisfactory level of basic requirements including characteristic at room temperature, characteristic after heating, oil resistance and hot set. The example 4 met a horizontal flame retardancy grade and exhibited a satisfactory level of the other characteristics.

According to a test for flame retardancy of the electrical wires manufactured using the compositions of the examples 1 to 6, which has never been listed in the conventional evaluation, the electrical wires met a smoke index of 25 or less in accordance with NES 711. Use of the surface treated metal hydroxide and the inorganic additive and the crosslink retardant allowed to remarkably reduce a whitening phenomenon of the electrical wire, improve extrudability of the material, resulting in smooth surface appearance, and eliminate a scotch problem that may occur during an extruding process.

The comparative example 1 used a blend of an unsaturated organosilane grafted ethylene-vinyl acetate copolymer resin containing 19% of vinyl acetate and an unsaturated organosilane grafted low density polyethylene resin as a base resin, and added magnesium hydroxide surface treated with vinyl silane, a brominated flame retardant and antimony trioxide. However, the comparative example 1 excluded a crosslink retardant, and thus crosslinking was proceeded during processing to reduce elongation at room temperature, and during compounding and extruding processes, silane was reacted with a hydroxyl group of a surface of the metal hydroxide to generate a plurality of protrusions due to scotch, thereby reducing extrudability.

The comparative example 2 excluded magnesium hydroxide from the example 1, and an electrical wire manufactured using a composition of the comparative example 2 did not meet the requirement of smoke index of 25 or less according to NES 711. Therefore, the electrical wire did not exhibit characteristics of an electrical wire having flame retardancy provided by the present invention, and met oil resistance but a resin swelling phenomenon was increased due to exclusion of a polar inorganic additive, thereby remarkably reducing oil resistance.

The comparative example 3 used a low density polyethylene free of unsaturated organosilane, instead of the unsaturated organosilane grated low density polyethylene of the example 1, and thus exhibited the improved elongation and extrudability, but showed a bad hot set test result and oil resistance due to reduction of crosslinking density by water.

The comparative example 4 used an unsaturated organosilane grafted linear low density polyethylene resin, instead of the unsaturated organosilane grated ethylene-vinyl acetate copolymer resin containing 19% of vinyl acetate used in the example 1, and thus the content of polyethylene was reduced due to use of an excessive amount of organic and inorganic additives, thereby rapidly reducing elongation and exhibiting poor extrudability.

As it was found from the evaluation of characteristics of the comparative example 1 to 4, in the case that the crosslink retardant was not used, it was difficult to improve extrudability and the entire characteristic, and in the case that the metal hydroxide was not used, flame retardancy and oil resistance were remarkably reduced. In the case that the polyethylene free of unsaturated organosilane was used, crosslinking density by water was reduced, and thus it was difficult to obtain oil resistance and hot set characteristic, and in the case that the unsaturated organosilane grafted ethylene-vinyl acetate copolymer resin was not used, it resulted in reduced elongation and poor extrudability due to use of much organic and inorganic additives.

It should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

The composition for manufacturing insulation materials of an electrical wire according to the present invention may eliminate a problem such as a scotch caused by high load that may occur when extruding an insulator and a sheath due to a high melting viscosity, have excellent oil resistance, heat resistance, flame retardancy and flame resistance and maintain characteristics including tensile strength and elongation when heating.

What is claimed is:

1. A composition for manufacturing insulation materials of an electrical wire, comprising:
100 parts by weight of a base resin, made by blending 20 to 70 weight % of any one resin of an unsaturated organosilane grafted polyethylene and an unsaturated organosilane grafted ethylene alpha olefine copolymer, and 30 to 80 weight % of an unsaturated organosilane grafted ethylene copolymer;
10 to 25 parts by weight of a brominated flame retardant;
10 to 50 parts by weight of an inorganic flame retardant; and
0.2 to 5 parts by weight of a compound, as a crosslink retardant, represented as a general formula of XₙSi(OR)₄₋ₙ (X is a phenyl group, R is a methyl group and n is an integer of 1 to 3).

2. The composition for manufacturing insulation materials of an electrical wire according to claim 1,
wherein the brominated flame retardant is any one selected from the group consisting of decabromodiphenylethylene, decabromodiphenyloxide and ethylene bis tetra bromophthalimide.

3. The composition for manufacturing insulation materials of an electrical wire according to claim 1,
wherein the inorganic flame retardant is any one selected from the group consisting of calcium carbonate, magnesium hydroxide and aluminum hydroxide.

4. The composition for manufacturing insulation materials of an electrical wire according to claim 1,
wherein the ethylene copolymer is any one selected from the group consisting of ethylene acetate vinyl copolymer, ethylene ethyl acrylate copolymer, ethylene methyl methacrylate copolymer and ethylene butyl acrylate copolymer.

5. The composition for manufacturing insulation materials of an electrical wire according to claim 1,
wherein acetate vinyl, ethyl acrylate, methyl methacrylate and butyl acrylate each has a content of 9 to 33 weight % in the ethylene acetate vinyl copolymer, ethylene ethyl acrylate copolymer, ethylene methyl methacrylate copolymer and ethylene butyl acrylate copolymer, respectively.

6. The composition for manufacturing insulation materials of an electrical wire according to claim 1,
wherein the polyethylene is any one selected from the group consisting of a low density polyethylene, a linear low density polyethylene and a high density polyethylene.

7. The composition for manufacturing insulation materials of an electrical wire according to claim 1,
wherein the ethylene alpha olefine copolymer is any one selected from the group consisting of butene-1, pentene-1, hexene-1, heptene-1, octene-1, 4-methylpentene-1, 4-methylhexene-1, 4,4-dimethylpentene-1, nonene-1, decene-1, undecene-1 and dodecene-1.

8. The composition for manufacturing insulation materials of an electrical wire according to claim 1, further comprising:
5 to 15 parts by weight of antimony trioxide based on 100 parts by weight of the base resin.

9. The composition for manufacturing insulation materials of an electrical wire according to claim 1, further comprising:
0.5 to 5 parts by weight of a lubricant based on 100 parts by weight of the base resin.

10. The composition for manufacturing insulation materials of an electrical wire according to claim 1, further comprising:
0.5 to 5 parts by weight of an antioxidant based on 100 parts by weight of the base resin, the antioxidant being any one selected from the group consisting of an amine-based antioxidant, a dialkylester-based antioxidant, a thioester-based antioxidant, a phenol-based antioxidant and their mixture.

11. An electrical wire coated with the insulating materials manufactured using the composition defined in any one of claims 1 to 10.
